(19) United States
(12) Patent Application Publication
(10) Pub. No.: US 2008/0123817 A1
(43) Pub. Date: May 29, 2008

(54) VOLUME CHANGE ABSORBER, X-RAY GENERATOR, AND X-RAY IMAGING APPARATUS

(76) Inventor: Asghar Ali Farooqui, Bangalore (IN)

Correspondence Address: PATRICK W. RASCHE (20459);ARMSTRONG TEASDALE LLP, ONE METROPOLITAN SQUARE, SUITE 2600, ST. LOUIS, MO, 63102-2740, US

(21) Appl. No.: 11/770,986

(22) Filed: Jun. 29, 2007

(30) Foreign Application Priority Data
Jul. 3, 2006 (JP) 2006-183621

(51) Int. Cl. H05G 1/02; F01B 19/00

(52) U.S. Cl. 378/193; 92/90; 378/200

(57) ABSTRACT

A volume change absorber simple in construction and wide in application range, an X-ray generator having such a volume change absorber, and an X-ray imaging apparatus having such an X-ray generator, are to be provided. The volume change absorber includes a rigid pipe-like member capable of being mounted in an airtight manner through a wall of a vessel into which liquid is sealed and a flexible tube having one end portion mounted so as to cover in an airtight manner an end portion of the portion of the pipe-like member which portion lies inside the vessel and also having an opposite end portion which is sealed in a crushed state.

### BACKGROUND OF THE INVENTION

The present invention relates to a volume change absorber, an X-ray generator and an X-ray imaging apparatus. Particularly, the present invention is concerned with a volume change absorber for absorbing a change in volume of liquid contained in a vessel, an X-ray generator having such a volume change absorber, and an X-ray imaging apparatus having such an X-ray generator.

In an X-ray generator for radiographing, an X-ray tube and a high voltage circuit are sealed together with an insulating liquid into a hermetically sealed vessel. The sealed liquid transmits heat generated from the X-ray tube and the high voltage circuit to the vessel, thus exhibiting a heat dissipating performance. The volume of the liquid changes due to a temperature change caused by the generation of heat from the X-ray tube and the high voltage circuit, therefore, a volume change absorber for absorbing such a change in volume is provided in the vessel. The volume change absorber is, for example, a flexible pipe formed of such a material as synthetic rubber. A change in volume of liquid is absorbed by a flexible deformation of the pipe. (See, for example, Patent Literature 1.)

[Patent Literature 1] U.S. Pat. No. 6,814,488

The volume change absorber is composed mainly of molded parts, but since it is dedicated to each X-ray generator to which the volume change absorber is applied, there are various shapes and sizes, thus requiring corresponding manufacturing equipment or techniques. Besides, the lead time up to completion is long. Moreover, a volume change absorber having a complicated shape requires a large number of items for finished products inspection and manufacturing steps, and the reliability and service life thereof are apt to be impaired by a complicated stress induced upon deformation.

### SUMMARY OF THE INVENTION

Therefore, it is an object of the present invention to provide a volume change absorber simple in construction and wide in application range, an X-ray generator having such a volume change absorber, and an X-ray imaging apparatus having such an X-ray generator.

### Means for Solving the Problems

In one aspect of the present invention for solving the above-mentioned problems there is provided a volume change absorber comprising a rigid pipe-like member capable of being mounted in an airtight manner through a wall of a vessel into which liquid is sealed and a flexible tube having one end portion mounted so as to cover an end portion of the portion of the pipe-like member which portion lies inside the vessel and further having an opposite end portion sealed in a crushed state.

In another aspect of the present invention for solving the above-mentioned problems there is provided an X-ray generator including an X-ray tube and a high voltage circuit both sealed together with liquid into a vessel having a volume change absorber, the volume change absorber comprising a rigid pipe-like member mounted in an airtight manner through a wall of the vessel and a flexible tube having one end portion mounted so as to cover an end portion of the portion of the pipe-like member which portion lies inside the vessel and further having an opposite end portion sealed in a crushed state.

In a further aspect of the present invention for solving the above-mentioned problems there is provided an X-ray imaging apparatus including an X-ray generator, the X-ray generator including an X-ray tube and a high voltage circuit both sealed together with liquid into a vessel having a volume change absorber, and an X-ray detector for detecting an X-ray emitted from the X-ray generator, the volume change absorber comprising a rigid pipe-like member mounted in an airtight manner through a wall of the vessel and a flexible tube having one end portion mounted so as to cover an end portion of the portion of the pipe-like member which portion lies inside the vessel and further having an opposite end portion sealed in a crushed state.

For mounting the pipe-like member in an airtight manner through the wall of the vessel it is preferable for the pipe-like member to comprise a flange portion capable of abutment against the wall of the vessel from the inside, an O-ring provided in an abutment surface of the flange portion, a threaded portion formed along the outer periphery of the portion of the pipe-like member which portion lies outside the vessel, and a nut capable of being threadedly engaged with the threaded portion and coming into abutment against the wall of the vessel from the outside.

For covering in an airtight manner an end portion of the portion of the pipe-like member which lies inside the vessel, it is preferable for the pipe-like member to comprise a tapered portion to be covered with the one end portion of the tube, a tapered washer for holding the one end portion of the tube in between it and the tapered portion, a threaded portion formed along the outer periphery of the portion of the pipe-like member which portion is not covered with the one end portion of the tube, and a lock nut threadedly engaged with the threaded portion to push the tube against the tapered portion through the tapered washer.

According to the above aspects of the present invention, since the volume change absorber comprises a rigid pipe-like member capable of being mounted in an airtight manner through a wall of a vessel into which liquid is sealed and a flexible tube having one end portion mounted so as to cover an end portion of the portion of the pipe-like member which portion lies inside the vessel and further having an opposite end portion sealed in a crushed state, it is possible to provide a volume change absorber simple in construction and wide in application range, an X-ray generator having such a volume change absorber, and an X-ray imaging apparatus having such an X-ray generator.

Further objects and advantages of the present invention will be apparent from the following description of the preferred embodiments of the invention as illustrated in the accompanying drawings.

### BRIEF DESCRIPTION OF THE DRAWINGS

FIG. 1 is a diagram showing the construction of an X-ray imaging apparatus as an example of the best mode for carrying out the present invention;

FIG. 2 is a diagram showing the construction of an X-ray generator as another example of the best mode;

FIG. 3 is a diagram showing the construction of a volume change absorber as a further example of the best mode; and

FIG. 4 is a diagram showing the construction of a tube.

### DETAILED DESCRIPTION OF THE INVENTION

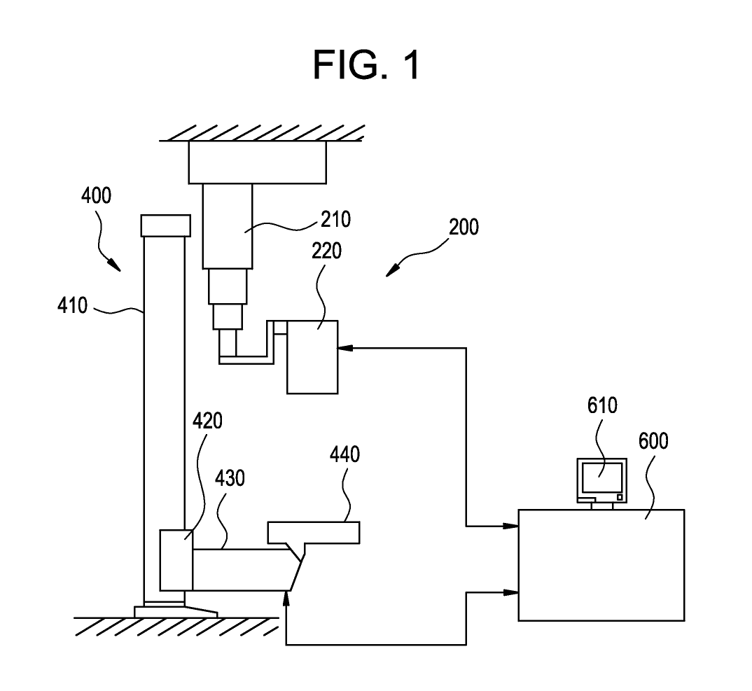

The best mode for carrying out the present invention will be described in detail hereinunder with reference to the drawings. The present invention is not limited to the best mode. FIG. 1 shows a schematic construction of an X-ray imaging apparatus. This system is an example of the best mode. With the construction of this system, there is shown an example of the best mode with respect to the X-ray imaging apparatus.

As shown in FIG. 1, this system includes an X-ray irradiating apparatus 200 and an X-ray detecting apparatus 400. In the X-ray irradiating apparatus 200, an X-ray source 220 is attached to a lower end of a column 210 suspended from a ceiling. The X-ray source 220 is constructed so that the direction thereof can be changed to change the X-ray irradiating direction. The column 210 which supports the X-ray source can expand and contract in the longitudinal direction and is movable horizontally along the ceiling. The X-ray source 220 is an example of the X-ray irradiator defined in the present invention.

In the X-ray detecting apparatus 400, a carriage 420 is mounted vertically movably to a column 410 which is upright from a floor, an arm 430 is attached horizontally to the carriage 420, and an X-ray detector 440 is attached to a free end of the arm 430.

The X-ray detector 440 is a flat plate-like structure and can tilt so that a light receiving surface thereof can become horizontal or vertical in accordance with an X-ray incidence direction. The X-ray detector 440 is an example of the X-ray detector defined in the present invention.

A detected signal from the X-ray detector 440 is inputted to an operator console 600. The operator console 600 reconstructs a radioscopic image of an object to be radiographed in accordance with the inputted signal provided from the X-ray detector 440 and displays it on a display 610. The X-ray detector 440 may be of a photosensitive material which is sensitive to X-ray. In this case, the radioscopic image is visualized by development.

Under operation performed by an operator, the operator console 600 controls both the X-ray irradiating apparatus 200 and the X-ray detecting apparatus 400. For the X-ray irradiating apparatus 200, not only horizontal and vertical positions of the X-ray source 220 and the X-ray irradiating direction are controlled, but also X-ray intensity and irradiation timing are controlled. For the X-ray detecting apparatus 400, not only the height of the X-ray detector 440 is controlled to match the X-ray source 220, but also the inclination of the light receiving surface is controlled so as to become horizontal or vertical in conformity with the X-ray incidence direction.

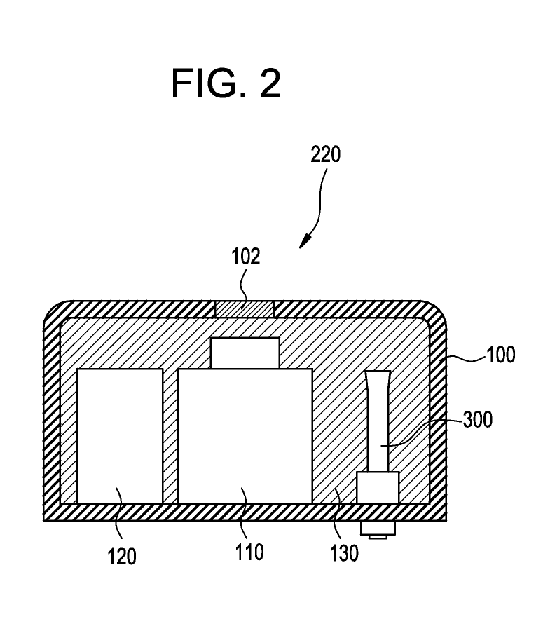

FIG. 2 shows schematically the construction of the X-ray source 220. With the construction of the X-ray source 220, there is shown an example of the best mode for carrying out the present invention with respect to the X-ray generator. In the X-ray source 220, as shown in FIG. 2, an X-ray tube 110 and a high voltage circuit 120 are sealed together with liquid 130 into a vessel 100. The liquid 130 is an electrically insulating liquid.

The vessel 100 is an example of the vessel defined in the present invention. The X-ray tube 110 is an example of the X-ray tube defined in the present invention. The high voltage circuit 120 is an example of the high voltage circuit defined in the present invention. The liquid 130 is an example of the liquid defined in the present invention.

The vessel 100 has a window 102 for the output of X-ray. The window 102 permits penetration of X-ray but does not permit penetration of the liquid 130. The vessel 100 has a volume change absorber 300. The volume change absorber 300 is for absorbing a change in volume of the liquid 130 caused by a change in temperature and it is mounted on a wall of the vessel 100 so as to extend through the wall.

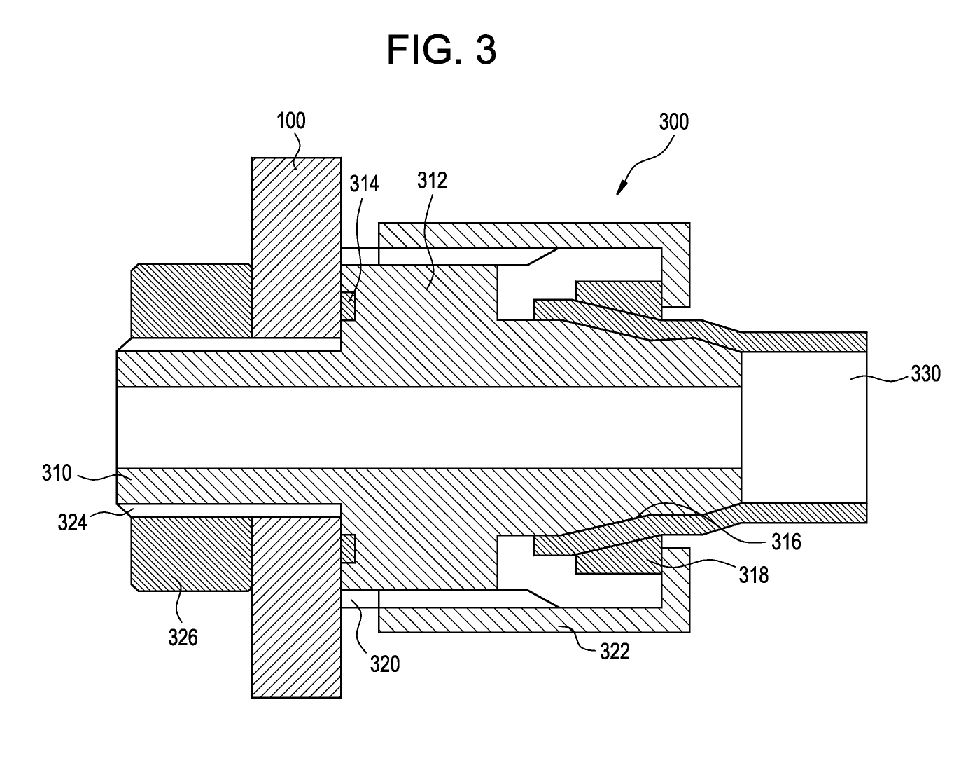

FIG. 3 shows schematically the construction of the volume change absorber 300. With the construction of the volume change absorber 300, there is shown an example of the best mode for carrying out the present invention with respect to the volume change absorber.

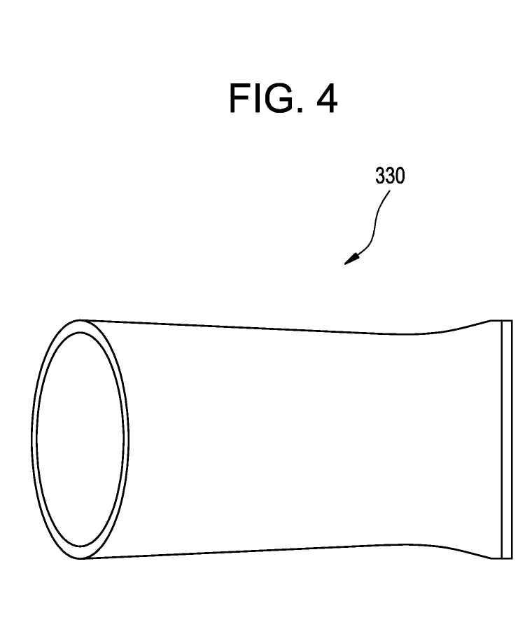

As shown in FIG. 3, the volume change absorber 300 is composed of a pipe-like member 310 and a tube 330 applied onto one end portion of the pipe-like member. The pipe-like member 310 is a hollow member which is open at both ends thereof. The tube 330 is a hollow body which is open at one end and sealed at the other end. The sealing of the other end is performed in such a crushed state as shown in FIG. 4. The pipe-like member 310 is an example of the pipe-like member defined in the present invention. The tube 330 is an example of the tube defined in the present invention.

The pipe-like member 310 is constituted by a material having rigidity. Examples of such a material include metal, ceramics and plastics. The tube 330 is constituted by a material having flexibility. Examples of such a material include rubber and plastics. It is optional whether the rubber is to be synthetic rubber or natural rubber.

The pipe-like member 310 has a flange portion 312 as an intermediate portion. The flange portion 312 is a portion for abutment against the wall of the vessel 100 from the inside. In the abutment surface of the flange portion 312 for abutment against the vessel wall there is provided an O-ring 314. In FIG. 3, the right and left sides of the vessel wall represent the interior and the exterior, respectively, of the vessel. The flange portion 312 is an example of the flange portion defined in the present invention. The O-ring 314 is an example of the O-ring defined in the present invention.

The portion of the pipe-like member 310 which portion is covered with the tube 330 is formed as a tapered portion 316. A tapered washer 318 engages the tapered portion 316 so as to pinch the tube 330. The tapered washer 318 is pushed by a lock nut 322 which is threadedly engaged with a threaded portion 320 formed along the outer periphery of the flange portion 312 and presses the tube 330 against the tapered portion 316. As a result, the tube 330 is fitted on the pipe-like member 310 in an airtight manner.

The tapered portion 316 is an example of the tapered portion defined in the present invention. The tapered washer 318 is an example of the tapered washer defined in the present invention. The threaded portion 320 is an example of the threaded portion defined in the present invention. The lock nut 322 is an example of the lock nut defined in the present invention.

A threaded portion 324 is formed along the outer periphery of the portion of the pipe-like member 310 which portion lies outside the vessel. A nut 326 is threadedly engaged with the threaded portion 324. The nut 326 pinches the vessel wall from both sides in cooperation with the flange portion 312, whereby the pipe-like member 310 is mounted on the vessel 100 in an airtight manner. The threaded portion 324 is an example of the threaded portion defined in the present invention. The nut 326 is an example of the nut defined in the present invention.

In the volume change absorber 300, the outside of the tube 330 is enclosed with the liquid 130 and the inside thereof is in communication with the exterior of the vessel 100, so that the tube 330 deforms flexibly in accordance with a change in volume of the liquid 130. The change in volume of the liquid 130 is absorbed by a change in volume of the tube 330 which results from such a deformation.

The volume change absorber 300 is formed by such a simple construction as the tube 330 being fitted on the pipe-like member 310, and is therefore superior in both reliability and service life of its product. Besides, the manufacturing process is simple and the cost is low. Further, the number of items for inspection of finished products is small and so is the number of manufacturing steps.

The tube 330 serving as a main component for absorbing a change in volume can be fabricated by cutting off a hose-like long member at a suitable length and sealing one end portion thereof in a crushed state. The crushing and sealing of the tube end portion can be done easily by a conventional technique.

The length of the long member to be cut off may be determined so as to provide a required tube volume. Thus, the same basic construction can be easily applied to various X-ray generators of different constructions. Therefore, it is not necessary to keep various kinds of parts and materials in stock. If several types of pipe-like members and tubes different in diameter are provided, it is possible to further expand the application range of volume change absorption.

Although a description has been given above about an example of the volume change absorber for the X-ray generator, the volume change absorber according to the present invention is widely applicable not only to the X-ray generator but also to liquid volume change absorbing uses in devices having liquid sealed within a vessel.

Many widely different embodiments of the invention may be configured without departing from the spirit and the scope of the present invention. It should be understood that the present invention is not limited to the specific embodiments described in the specification, except as defined in the appended claims.

1. A volume change absorber comprising:
a rigid pipe-like member capable of being mounted in an airtight manner through a wall of a vessel into which liquid is sealed; and
a flexible tube having one end portion mounted so as to cover an end portion of the portion of the pipe-like member which portion lies inside the vessel and further having an opposite end portion sealed in a crushed state.

2. A volume change absorber according to claim 1, wherein the pipe-like member comprises:
a flange portion capable of abutment against the wall of the vessel from the inside; and
an O-ring provided in an abutment surface of the flange portion and capable of sealing the flange portion and the wall of the vessel from the inside.

3. A volume change absorber according to claim 1, wherein the pipe-like member comprises:
a tapered portion to be covered with the one end portion of the tube; and
a tapered washer for holding the one end portion of the tube in between it and the tapered portion.

4. An X-ray generator including an X-ray tube and a high voltage circuit both sealed together with liquid into a vessel having a volume change absorber, the volume change absorber comprising:
a rigid pipe-like member mounted in an airtight manner through a wall of the vessel; and
a flexible tube having one end portion mounted so as to cover an end portion of the portion of the pipe-like member which portion lies inside the vessel and further having an opposite end portion sealed in a crushed state.

5. An X-ray generator according to claim 4, wherein the pipe-like member comprises:
a flange portion capable of abutment against the wall of the vessel from the inside; and
an O-ring provided in an abutment surface of the flange portion and capable of sealing the flange portion and the wall of the vessel from the inside.

6. An X-ray generator according to claim 4, wherein the pipe-like member comprises:
a tapered portion to be covered with the one end portion of the tube; and
a tapered washer for holding the one end portion of the tube in between it and the tapered portion.

7. An X-ray imaging apparatus including an X-ray generator, the X-ray generator including an X-ray tube and a high voltage circuit both sealed together with liquid into a vessel having a volume change absorber, and an X-ray detector for detecting an X-ray emitted from the X-ray generator, the volume change absorber comprising:
a rigid pipe-like member mounted in an airtight manner through a wall of the vessel; and
a flexible tube having one end portion mounted so as to cover an end portion of the portion of the pipe-like member which portion lies inside the vessel and further having an opposite end portion sealed in a crushed state.

8. An X-ray imaging apparatus according to claim 7, wherein the pipe-like member comprises:
a flange portion capable of abutment against the wall of the vessel from the inside; and
an O-ring provided in an abutment surface of the flange portion and capable of sealing the flange portion and the wall of the vessel from the inside.

9. An X-ray imaging apparatus according to claim 7, wherein the pipe-like member comprises:
a tapered portion to be covered with the one end portion of the tube; and
a tapered washer for holding the one end portion of the tube in between it and the tapered portion.

10. A volume change absorber according to claim 2, wherein the pipe-like member further comprises:
a threaded portion formed along the outer periphery of the portion of the pipe-like member which portion lies outside the vessel; and
a nut capable of being threadedly engaged with the threaded portion and coming into abutment against the wall of the vessel from the outside such that the flange abuts the wall of the vessel from the inside.

11. A volume change absorber according to claim 3, wherein the pipe-like member further comprises:
a threaded portion formed along the outer periphery of the portion of the pipe-like member which portion is not covered with the one end portion of the tube; and
a lock nut threadedly engaged with the threaded portion to push the tube against the tapered portion through the tapered washer.

12. An X-ray generator according to claim 5, wherein the pipe-like member further comprises:
a threaded portion formed along the outer periphery of the portion of the pipe-like member which portion lies outside the vessel; and
a nut capable of being threadedly engaged with the threaded portion and coming into abutment against the wall of the vessel from the outside such that the flange abuts the wall of the vessel from the inside.

13. An X-ray generator according to claim 6, wherein the pipe-like member further comprises:
a threaded portion formed along the outer periphery of the portion of the pipe-like member which portion is not covered with the one end portion of the tube; and
a lock nut threadedly engaged with the threaded portion to push the tube against the tapered portion through the tapered washer.

14. An X-ray imaging apparatus according to claim 8, wherein the pipe-like member further comprises:
a threaded portion formed along the outer periphery of the portion of the pipe-like member which portion lies outside the vessel; and
a nut capable of being threadedly engaged with the threaded portion and coming into abutment against the wall of the vessel from the outside such that the flange abuts the wall of the vessel from the inside.

15. An X-ray imaging apparatus according to claim 9, wherein the pipe-like member further comprises:
a threaded portion formed along the outer periphery of the portion of the pipe-like member which portion is not covered with the one end portion of the tube; and
a lock nut threadedly engaged with the threaded portion to push the tube against the tapered portion through the tapered washer.

16. A volume change absorber according to claim 1 wherein the tube is configured to deform in response to a change in volume of the liquid.

17. A volume change absorber according to claim 1 wherein the portion of the tube that lies within the vessel is enclosed in the liquid sealed within the vessel.

18. An X-ray generator according to claim 4 wherein the tube is configured to deform in response to a change in volume of the liquid.

19. An X-ray generator according to claim 4 wherein the portion of the tube that lies within the vessel is enclosed in the liquid sealed within the vessel.

20. An X-ray imaging apparatus according to claim 7 wherein the tube is configured to deform in response to a change in volume of the liquid.
